(19) United States
(12) Patent Application Publication
(10) Pub. No.: US 2007/0091479 A1
(43) Pub. Date: Apr. 26, 2007

(54) Combination mirror and turn signal for vehicles

(76) Inventor: Marcus Penny, Dallas, TX (US)

Correspondence Address: CRUTSINGER & BOOTH, 1601 ELM STREET, SUITE 1950, DALLAS, TX, 752014744, US

(21) Appl. No.: 11/253,860

(22) Filed: Oct. 19, 2005

(51) Int. Cl. G02B 5/08; G02B 7/18

(52) U.S. Cl. 359/841

(57) ABSTRACT

The present invention has a rear view mirror assembly in a housing, with a slidable or pivotable housing portion movable along a generally vertical plane, from a first, streamlined position to a second position, so as to expose a front facing planar surface to view from ahead of the vehicle and a rear facing planar surface to view from behind the vehicle.

### TECHNICAL FIELD

The present invention relates generally to the field of motor vehicles with externally mounted rear view mirror assemblies and more particularly to the mounting of turn signal lights integral to such mirror assemblies.

### BACKGROUND

Turn signals for motor vehicles are well known and relied upon by drivers for advising others, both drivers and pedestrians, of their intentions and for anticipating lane changes and turns by other vehicles. Brake lights serve much the same purpose in alerting following vehicles of imminent speed changes, with some limitations due to proximity or relative positions. Motor Vehicle Safety Standards have been upgraded to require a high, centrally located brake light, in order to make the braking signal more readily seen by all. There is a similar necessity for all to be aware of a driver's intentions as to lane changes and making turns, regardless of proximity or relative positions. The vehicles in front and on either side will be well served if they are made aware of a driver's intentions. The interior of an automobile is an isolation chamber, separating the driver from everyone else, with only lights and a horn for communication. Unfortunately, horn signals are irritating negatives by nature and easily misunderstood. Since miscommunication can result in road rage and worse, signals are best rendered visually, clearly and positively.

A first object of the present invention is, therefore, to provide turn signals in a form that will be seen by other drivers in close quarters, regardless of relative position. A second object is that the aforesaid turn signals convey a clear message in a positive manner.

### SUMMARY OF THE INVENTION

The present invention relates to or employs some steps and apparatus well known in the mechanical arts so, therefore, is not the subject of detailed discussion herein. This invention addresses the aforesaid objectives in a preferred embodiment employing familiar, uncomplicated technology.

The present invention is a rear view mirror on a supporting structure having an extension configured for attachment to the outside of the vehicle. The rear view mirror is mounted to the supporting structure, preferably in a manner that permits angular adjustment by the driver. The mirror and its supporting structure are shrouded by a forwardly extended housing having a bulbous, streamlined shape. In the invention, a portion of the forwardly extended housing is displaced to expose turn signal displays on generally vertical planes, visible to others ahead of and behind the vehicle. A preferred embodiment of the invention has the forwardly extended housing divided along a generally vertical plane into front and rear housing portions. The front portion is displaced from the passive position to expose two essentially planar faces, one visible from the front and the other visible from the rear. Thus, a direction indicating display on one face is hidden in the passive position and visible from the front in the displaced position and a direction indicating display on the other face, also hidden in the passive position, is visible from the rear in the offset position. Various mechanisms for effecting the movement when the driver selects a turn signal include solenoid actuators, motor driven screw mechanisms and rotary actuators.

In an alternative embodiment, a portion of the forwardly extended housing is displaced from the passive position along a generally vertical plane to expose two essentially planar surfaces of the portion, with direction indicating displays, one visible from the front and one from the rear. In any embodiment, the display may be illuminated or passive. The display may be a simple blinker or a shaped symbol, such as an arrow or “happy face” display.

### BRIEF DESCRIPTION OF THE DRAWINGS

The accompanying drawings are incorporated into the specification to assist in explaining the present invention. The drawings illustrate preferred and alternative examples of how the invention can be made and used and are not to be construed as limiting the invention to only those examples illustrated and described. The various advantages and features of the present invention will be apparent from a consideration of the drawings in which:

FIG. 1 is a view, as seen from in front of the vehicle, of a preferred embodiment of the present inventions, with a broken out section of the front housing, to show the actuating mechanism;

FIG. 2 is a top view of the embodiment of FIG. 1;

FIG. 3 is a view of the embodiment of FIG. 1 as seen from the rear;

FIG. 4 is a view of the embodiment of FIG. 1 in the passive position as seen from the rear;

FIG. 5 is a view of the embodiment of FIG. 1 in the actuated position as seen from the front;

FIG. 6 is a view of an alternative, sliding embodiment of the present invention as seen from the front;

FIG. 7 is a view, as seen from in front of the vehicle, of a second sliding embodiment of the present inventions, with a broken out section to show the actuating mechanism; and

FIG. 8 is a cross-section view of the actuating mechanism of FIG. 7.

### DETAILED DESCRIPTION OF THE DRAWINGS

The present invention is described in the following by referring to drawings of examples of how the invention can be made and used. In these drawings, reference characters are used throughout the views to indicate corresponding parts. The embodiment shown and described herein is exemplary. Many details are well known in the art, and as such may be neither shown nor described. This invention addresses the aforesaid objects by teaching a way to adapt the external rear view mirrors of a vehicle to also display turn signals.

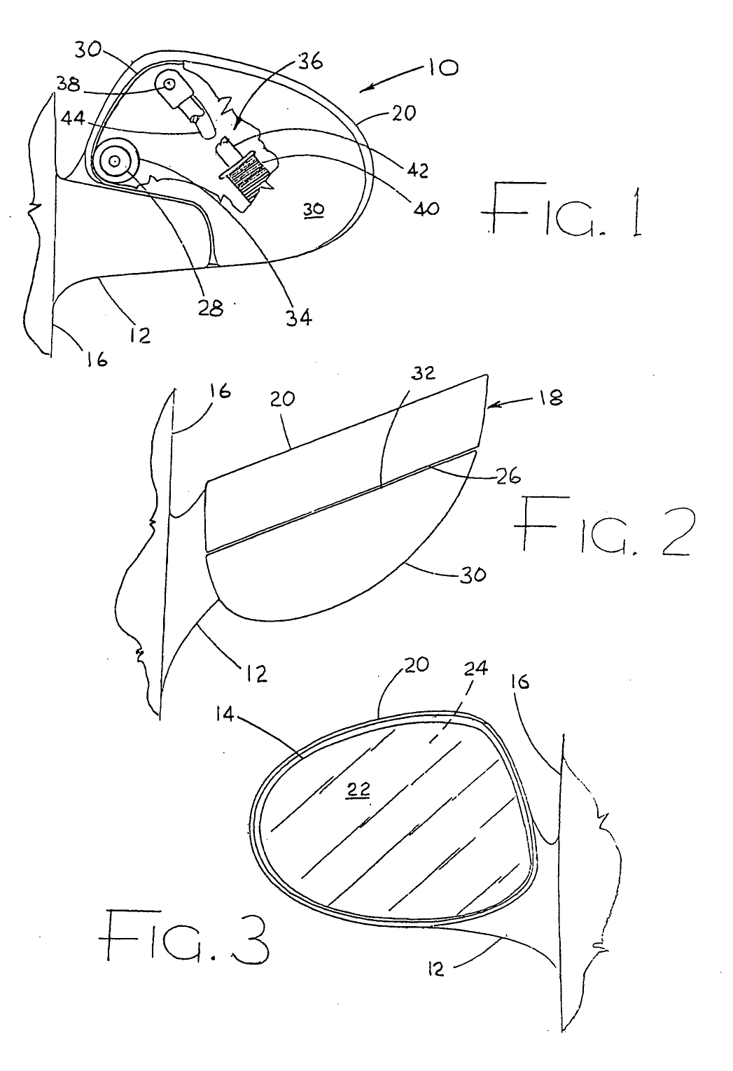

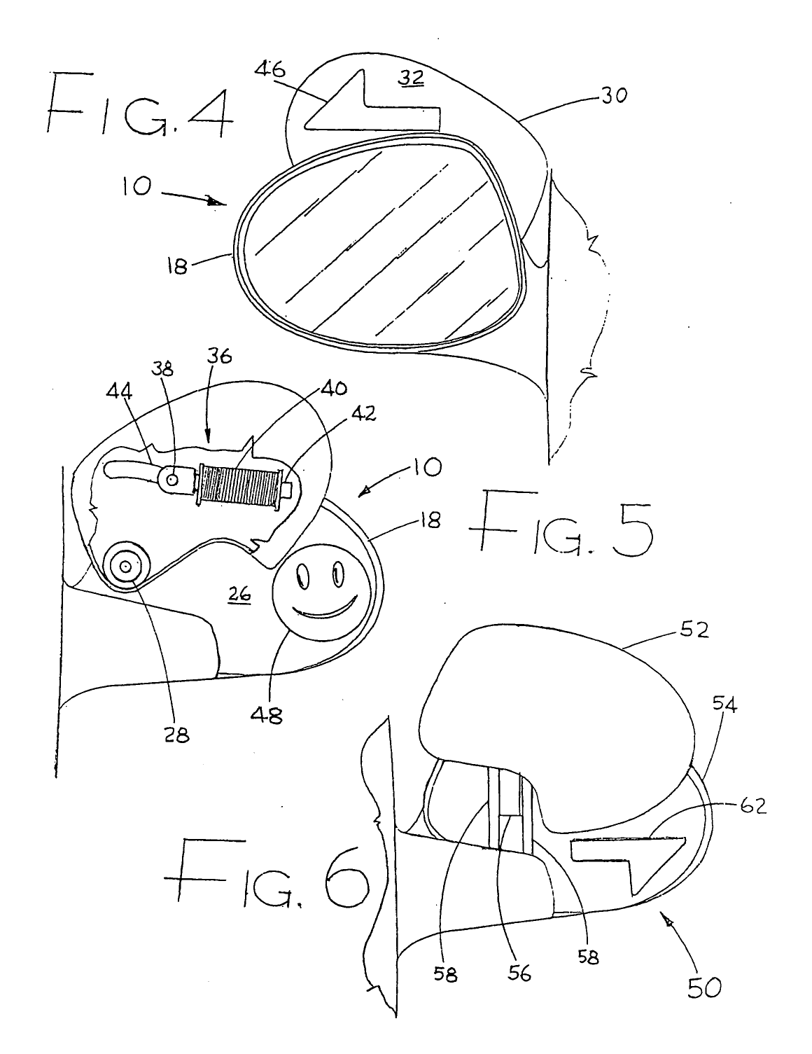

FIGS. 1-3 show front, top and rear views of preferred embodiment 10 of the present invention, as it appears in the first, passive position. Mounting extension 12 is adapted to support rear view mirror assembly 14 and provide for its structural mounting to vehicle side 16. Mirror assembly 14 comprises a rear housing portion 18 with peripheral member 20 serving as a shroud around mirror 22. Also contained in rear housing portion 18 is a mirror support structure 24, of a form made to provide for angular adjustment of the reflected field of view. Mirror support structure 24 is well known in the art and, hence, not shown or discussed herein. Front face 26 of rear housing portion 18 is generally planar and includes a hollow, fixed pivot shaft 28 and fixed actuator connecting pin 38 for the mounting of front housing portion 30 with its streamlined shape and generally planar rear face 32 against front face 26. Front housing portion 30 is broken away to reveal fixed bushing 34 fitted to shaft 28 for pivotal movement between the first passive position, as shown here, and a second position. (FIGS. 4 and 5.) The hollow center of shaft 28 provides for the passage of electrical wiring (not shown) into front housing 30, for power to actuating mechanism 36. Actuating mechanism 36 is shown to be linear, in this case a solenoid coil 40 and plunger 42, but could just as well be an electric motor driven screw or rotary actuator, all of which are devices well known to the vehicular arts. Notably, plunger 42 is shown in an interrupted view, to reveal slot 44. Slot 44 affords an open path in rear face 32 for penetration and movement of actuator connecting pin 38.

FIGS. 4 and 5 show rear and front views of preferred embodiment 10 of the present invention, as described in FIGS. 1-3, as it appears in the active, second position, wherein front housing 30 is pivoted upwardly with respect to rear housing 18. In FIG. 4, the rear face 32 of front housing 30 is shown to include directional signal display 46 on its rearwardly visible portion. Display 46 may be rendered in color or may be illuminated for greater visibility. In any case, the movement of front housing 30 by itself will attract attention to directional signal display 46.

In FIG. 5, the working of actuating mechanism 36 is illustrated in a broken out view of front housing 32. Plunger 42 is seen to be pulled into solenoid coil 40 as it is energized. Although solenoid coil 40 is affixed to front housing 32, the loose fit of plunger 42 is sufficient to accommodate the arcuate path in slot 44 of actuator connecting pin 38 as front housing 32 pivots upwardly on fixed shaft 28 to its second position. In this position, the front face 26 of rear housing 18 is shown to include turn signal display 48 on its forwardly visible portion. In a Puckish, and hopefully contagious display of good cheer, turn signal display 48 is shown as a “Happy Face” instead of a directional arrow. (FIGS. 4, 6 and 7.) The “Happy Face” is, of course, but one example of a symbol which may be used as the directional indicator.

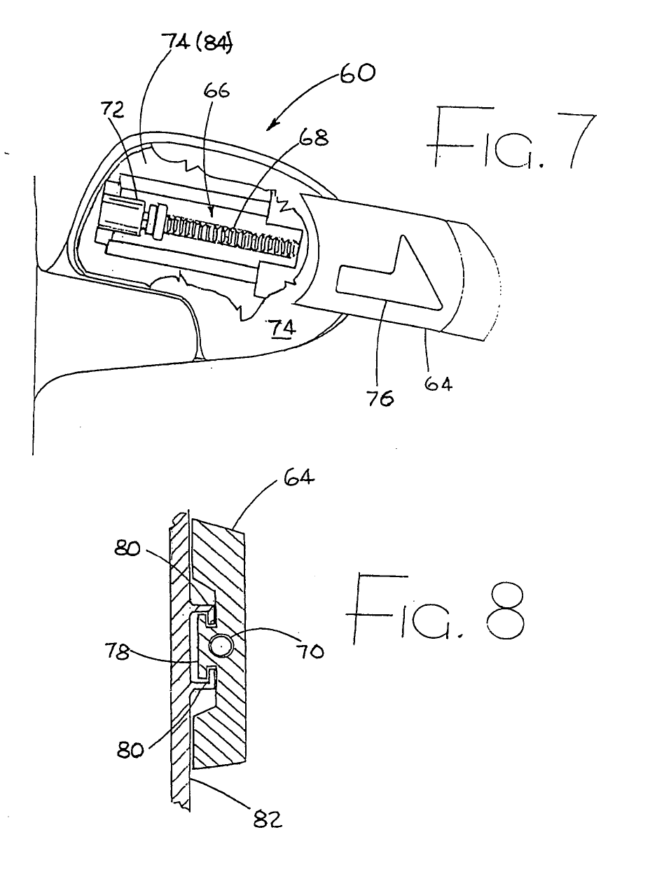

FIG. 6 shows an alternative embodiment 50 of the present invention, in which the movement of otherwise similar front housing 52 with respect to otherwise similar rear housing 54 is implemented in the same generally vertical plane as a linear, but as a sliding motion rather than the pivoting movement of embodiment 10. Here, guide member 56 slides in tracks 58, powered by a similar linear actuator (FIGS. 7 and 8) to displace front housing vertically to its active, second position and expose directional signal display 62.

FIGS. 7 and 8 show a second alternative embodiment 60, which is similar to embodiment 50, with horizontal movement of slidable member 64 in a generally vertical plane rather than vertical movement as in FIG. 6. Here, the inner workings and movement are similar to the showing of FIG. 6. The linear actuator is, in this example, screw and nut arrangement 66, wherein screw 68 engages internal screw threads 70 in slidable member 64. Motor 72 drives screw 68 to rotate counter clockwise, so as to extend slidable member 64 from front housing 74 and expose direction indicating displays 76 on its planar front and rear surfaces to view from both directions. As in the previous examples, display 76 may be illuminated or simply colored. Reversing rotation of motor 72, to drive screw 68 in a clockwise direction, draws slidable member 64 back into streamlined front housing 74. The sliding movement of slidable member 64 is guided by the engagement of guide member 78 in tracks 80

FIG. 8 is a cross-section view of the mechanism of embodiment 60, wherein slidable member 64 is seen to be formed with integral internal screw threads 70 and guide member 78. Guide member 78 has a “T” shaped cross-section adapted to guided linear movement between tracks 80, as formed in wall 82, either the rear of front housing 74 or the front of rear housing 84.

The embodiments shown and described above are exemplary. It is not claimed that all of the details, parts, elements, or steps described and shown were invented herein. Even though many characteristics and advantages of the present inventions have been described in the drawings and accompanying text, the description is illustrative only. Changes may be made in the detail, especially in matters of shape, size, and arrangement of the parts within the scope and principles of the inventions. The restrictive description and drawings of the specific examples above do not point out what an infringement of this patent would be, but are to provide at least one explanation of how to use and make the inventions. The limits of the inventions and the bounds of the patent protection are measured by and defined in the following claims.

I claim:

1. Apparatus for a vehicular turn signal comprising:
a rear view mirror support structure having an extension configured for attachment to the outside of the vehicle;
a rear view mirror mounted on the support structure;
a forwardly extended housing having a first portion shrouding the mirror and support structure and a second portion, movable from a first, passive position along a generally vertical plane to a second, active position, so as to expose a first generally planar surface to view from ahead of the vehicle and a second generally planar surface to view from behind the vehicle;
an actuating mechanism for moving the second housing portion between the first and second positions; and
direction indicating displays on at least one of the first and second generally planar surfaces.

2. Apparatus according to claim 1, wherein the actuating mechanism is a solenoid coil and plunger.

3. Apparatus according to claim 1, wherein the actuating mechanism is a screw and nut mechanism.

4. Apparatus according to claim 1, wherein the actuating mechanism is a rotary actuator.

5. Apparatus according to claim 1, wherein the direction indicating display is a directional arrow.

6. Apparatus according to claim 1, wherein the direction indicating display is a symbol.

7. Apparatus for a vehicular turn signal comprising:
a rear view mirror support structure having an extension configured for attachment to the outside of the vehicle;
a rear view mirror mounted on the support structure;
a forwardly extended housing shrouding the mirror and support structure and having a generally streamlined shape;
a housing portion, movable from a first position, within the streamlined shape, to a second position, so as to expose a front facing generally planar surface to view from ahead of the vehicle and a rear facing generally planar surface to view from behind the vehicle; and
direction indicating displays on the front and rear facing generally planar surfaces.

8. Apparatus according to claim 7, wherein the housing portion is movable along a generally vertical plane.

9. Apparatus according to claim 7, wherein the actuating mechanism is a screw and nut mechanism.

10. Apparatus according to claim 7, wherein the actuating mechanism is a rotary actuator.

11. Apparatus according to claim 7, wherein the direction indicating display is a directional arrow.

12. Apparatus according to claim 7, wherein the direction indicating display is a “Happy Face” symbol.

13. Apparatus for a vehicular turn signal comprising:
a rear view mirror mounting structure having an extension for external side mounting on a vehicle;
a rear view mirror mounted on the mirror mounting structure;
a peripheral rear housing member around the mirror and mounting structure and covering the mounting structure with a generally flat front face;
a front housing member having a rear face fitting against the front face of the rear housing member and movable with respect to the rear housing member between a first, matching position and a second, offset position;
a direction indicating display on the front face, hidden in the matching position and visible from the front in the offset position;
a direction indicating display on the rear face, hidden in the matching position and visible from the rear in the offset position; and
actuating means for selectively moving the front housing member between the first and second positions.

14. Apparatus according to claim 13, wherein the second position is generally vertically displaced from the first position.

15. Apparatus according to claim 13, wherein the second position is generally horizontally displaced from the first position.

16. Apparatus according to claim 13, wherein the actuating mechanism is a rotary actuator.

17. Apparatus according to claim 13 wherein the direction indicating display is a directional arrow.

18. Apparatus according to claim 13, wherein the direction indicating display is a symbol.
